(19) United States
(12) Patent Application Publication
(10) Pub. No.: US 2018/0138790 A1
(43) Pub. Date: May 17, 2018

(54) POSITIVELY BALANCING AN ARMATURE

(71) Applicant: Rausch & Pausch GmbH, Selb (DE)

(72) Inventors: Ernst Fleischmann, Rehau (DE); Rocco Kemnitz, Bobenneukirchen (DE)

(73) Assignee: Rausch & Pausch GmbH, Selb (DE)

(21) Appl. No.: 15/806,623

(22) Filed: Nov. 8, 2017

(30) Foreign Application Priority Data
Nov. 14, 2016 (DE) 10 2016 121 766.2

(51) Int. Cl. H02K 15/16; H02K 15/12; H02K 15/03; H02K 1/27; H02K 1/28; B29C 45/14

(52) U.S. Cl. CPC H02K 15/165; H02K 15/12; H02K 15/03; B29K 2101/12; H02K 1/28; B29C 45/14336; H02K 1/276

(57) ABSTRACT

A method for producing a positively balanceable internal armature to be used in an electric motor, in particular a direct-current electric motor, which makes it possible that the structural group is configured such that a balancing of the internal armature can take place with little technical effort. A manufacturing apparatus which is arranged to execute the proposed method or which can be operated by the proposed method. Further, an internal armature to be used in an electric motor as well as to the electric motor itself. Further, a computer program product is proposed, having control commands which implement the proposed method or operate the proposed manufacturing apparatus.

### FIELD

The present invention is directed to a method for producing a positively balanceable internal armature to be used in an electric motor, in particular a direct-current electric motor, which method makes it possible that the structural group is configured such that a balancing of the internal armature can take place with particularly little technical effort and particularly cleanly. The invention is further directed to a manufacturing apparatus which is arranged to execute the proposed method or which can be operated by means of the proposed method. Further, the present invention is directed to an internal armature to be used in an electric motor as well as to the electric motor itself. Further, a computer program product is proposed, having control commands which implement the proposed method or operate the proposed manufacturing apparatus.

### BACKGROUND

DE 10 2013 013 650 A1 shows a rotatably mounted rotation body, in particular a fan wheel with a device for balancing, characterized by at least one cavity disposed in the rotation body for incorporating a balancing substance as well as by a specific balancing substance disposed in the cavity. But here the focus is on a fan which basically has properties different from an internal armature.

DE 20 2011 101 568 U1 shows an electric machine having a stator and a rotor rotatable relative thereto, the rotor comprising a rotor shaft with a magnet body and at least one balancing disk and being rotatably disposed in a magnetic field of the stator generated by a current-carrying coil.

DE 10 2012 000 497 A1 shows a rotation component whose mass body is provided with at least one balancing weight for improving its mass symmetry with respect to its axis of rotation, the at least one balancing weight being formed from solder applied on the mass body in a soldering process.

According to known methods, rotatory electric machines are supplied, for example permanently excited direct-current electric motors for an application in the motor vehicle region. Here, the motor has a rotor constructed from a sheet pack with permanent magnets disposed in the sheet pack in flux-concentrated fashion. For that purpose, the permanent magnets are inserted into end-face openings in the sheet pack. To secure the permanent magnets against loss under operation loads and for the service life of the electric machine, the rotor sheet pack equipped with the permanent magnets is overmolded with a thermoplastic.

Depending on the application and operating conditions, the rotating structural group must be balanced. This is necessary for avoiding spurious excitations caused by an asymmetric mass distribution. In general, one distinguishes between positive balancing, i.e. adding material, and negative balancing, i.e. removing material. Negative balancing causes process-induced contamination, because material is removed and therefore detached. This removed material may not be carried away and soil the structural group. With regard to cleanness upon assemblage this balancing principle is hence of disadvantage.

With positive balancing the challenge is to fasten the added material firmly enough for all operating conditions and the service life. According to conventional methods it is particularly disadvantageous that, for example, with negative balancing during a milling or drilling process the removed material can penetrate the structural group such that contaminations result therefrom which disturb the operation of the electric motor. Furthermore, a weakening of the carrier material may have to be taken into account, because mass is removed from components which in particularly disadvantageous methods are unstable with regard to a force acting thereon. Moreover, it is particularly disadvantageous that corresponding processing steps for milling or drilling are carried out during the balancing process and are not carried out already at the time of production of the electric motor. Moreover, the milling of material is typically irreversible.

With positive balancing there occurs the problem that additional balancing weights are often incorporated according to the prior art such that in particular with great forces occurring during the operation of the electric motor these are not reliably fixed such that these may detach after some time. Thus, methods are known in which balancing elements may come out from the structural group of the internal armature and therefore can possibly break off. Furthermore, methods are known in which an adhesive connection is attached such that the balancing elements are fixed at a suitable place on the structural group. Here, it has to be considered, however, that particularly under the action of temperature an adhesive connection typically is unstable or can become unstable and therefore in turn the fixation of the balancing elements is not reliably enough.

Particularly for the balancing of rotors or for the production of such rotors the person skilled in the art will always search for improved solutions which make it possible to carry out the balancing with little technical effort or to prepare the balancing already at the time of production of the motor. This is the case in particular because upon an unfavorable or asymmetric weight distribution of rotation elements great forces may arise which in turn endanger the proper functioning of the electric motor as such. For this, a balancing is operated in particularly complex methods so as to ward off damage from an electric motor.

### SUMMARY

It is hence an object of the present invention to propose a method which makes it possible with little technical effort to carry out a balancing of an internal armature or to prepare the balancing already in the production process of the internal armature. It is necessary here that for balancing the balancing elements can be placed with simple technical means and additionally are fixed so rigidly that the balancing elements are permanently connected with the structural group to be balanced. It is further an object of the present invention to supply an accordingly arranged manufacturing apparatus which executes the method or is operated by means of the proposed method. Further, it is an object of the present invention to propose an internal armature configured according to the method as well as to supply an electric motor which has the internal armature. Further, it is an object of the present invention to supply a computer program product with control commands which implement the proposed method or operate the proposed manufacturing apparatus.

Accordingly, there is proposed a method for producing a positively balanceable internal armature to be used in an electric motor, comprising supplying a rotor sheet pack, overmolding the supplied rotor sheet pack with a thermoplastic, wherein configuring the plastic overmolding is effected such that on at least one end face of the rotor sheet pack there are shaped recesses for receiving balancing elements.

An electric motor which is formed as a so-called internal armature has a rotor and a stator which concentrically surrounds the rotor forming an annular air-gap. The stator here has a multi-phase, in particular three-phase field winding usually formed from several coils for generating a magnetic field, in which the rotor usually provided with permanent magnets rotates for generating a rotor force. The rotor here is normally formed from a sheet pack which has a plurality of single metal sheets and is carried by a rotor shaft or machine shaft and is fixed thereto. For this, permanent magnets are typically attached in a number of recesses in the structural group. Therefore, the electric motor according to the invention comprises a rotor sheet pack with several magnets, the rotor sheet pack being connected to a shaft in a fixed manner for co-rotation.

Since, however, a rotor sheet pack is not completely tight, such a rotor sheet pack is typically overmolded with a thermoplastic. This shall avoid, for example, corrosion phenomena. Otherwise, the constituents of the rotor, in particular the magnets, could be attacked by liquids. Further, penetrating liquids would lead to imbalance phenomena.

Rotating bodies, for example an internal armature or the rotor sheet pack, temporarily rotate at high speeds and are also provided for a rotation at different rotation speeds. For this, various types of bearings are provided which absorb continuous radial and axial loads on a rotor, on the one hand, and also irregular forces, such as for example those arising from a divergence of the actual axis of rotation and the ideal axis of inertia or gyro axis of a body, on the other hand. Within an electric motor there typically act gyroscopic forces which are also referred to as imbalance and are typically avoided by incorporating balancing weights at suitable places. Here, it was recognised according to the invention that overmolding the rotor sheet pack with thermoplastic can already be used for providing corresponding recesses at the structural group which in further method steps can be used according to the invention to place balancing elements.

Thus, according to the invention, the rotor which is also referred to as internal armature is supplied such that, for example, a conventional rotor sheet pack is overmolded with thermoplastic such that recesses arise which are suitable for receiving balancing elements, such as for example steel spheres. Therefore, it is particularly advantageous that according to the invention known rotor sheet packs can be reused such that these are improved merely in the plastic overmolding being configured according to the invention. Therefore, according to the invention there is proposed an internal armature or a method for producing such an internal armature which is suitable for use in an electric motor, preferably a direct current motor. Here, the person skilled in the art recognizes that further conventional components have to be available, such as for example a stator which in cooperation with the internal armature or the rotor constitutes an electric motor.

The rotor sheet pack comprises, among other things, permanent magnets which by means of further conventional components are subjected to magnetic forces such that the rotor sheet pack starts moving in rotating fashion and rotates around the longitudinal axis of the rotor sheet pack. Therefore, the method step of supplying the rotor sheet pack can generally be effected by supplying a known rotor sheet pack and the subsequent overmolding process being modified such that on at least one end face of the rotor sheet pack, preferably on both end faces, a plurality of recesses is shaped for receiving balancing elements. This plurality can be a number of 3 to 100 recesses for balancing elements. The number of recesses here is based on generally known configurations, in which for example 40 to 50 recesses are to be provided. Here, the person skilled in the art recognizes that he selects the number of recesses accordingly in dependence on the dimension of the rotor sheet pack. For respectively greater electric motors there are hence required higher numbers of recesses, and for smaller electric motors less recesses accordingly.

It is also advantageous to select the size of the balancing elements accordingly in dependence on the dimensions of the electric motor or of the rotor sheet pack to be balanced. According to the invention it is hence possible to select the incorporated recesses in their dimensions and geometry already such that predetermined balancing elements can be placed therein.

Configuring the plastic overmolding is effected such that on at least one end face of the rotor sheet pack there are shaped recesses for receiving balancing elements. Basically, this is possible by the plastic overmolding itself already having recesses which are, thus, incorporated during the molding process, or however, by a conventional overmolding being effected and the recesses being incorporated afterwards. It is thus possible that the process of overmolding and configuring the plastic overmolding is effected such that both method steps coincide. An overmolding of the supplied rotor sheet pack hence comprises configuring the plastic overmolding. This can be effected, for example, by elements being brought toward the rotor sheet pack or being placed against it already during the overmolding process, which elements are removed after the overmolding process. Therefore, recesses will remain which have the geometry of such elements. For example, the thermoplastic can be heated by action of temperature until the rotor sheet pack can be overmolded and, in addition, respective recess elements be brought toward it. Before a cooling and therefore curing of the thermoplastic, corresponding elements can then be removed, so that the plastic overmolding cures without the recesses created thereby closing.

Additionally or alternatively, it is also possible to carry out a conventional overmolding and to vary it in a subsequent method step such that recesses are introduced into the conventional overmolding. It is thus possible, for example to introduce corresponding recesses into the conventional overmolding by means of drilling or milling. Incorporating recesses implies that the recesses are opened outwardly, so that no closed cavity is formed, because otherwise the balancing elements would not be incorporable into the recess. Hence, it is always to be ensured that the recesses are configured such that balancing elements can be pressed or forced into these. The recesses are then suitable for receiving balancing elements, and balancing elements can be incorporated into the recesses preferably in form-flush fashion. If the balancing elements are not incorporated in form-fitting fashion into the recess, further filler materials or processing steps may possibly be required.

According to an aspect of the present invention, the shaping of recesses is effected during the overmolding. This has the advantage that the overmolding and the configuring can be carried out already in one single production step and the overmolding is effected already such that recesses for receiving balancing elements are shaped. This is advantageous in particular because by the two steps coinciding a particularly efficient method is created which avoids that recesses must be created subsequently to the overmolding in such a way that first the thermoplastic material must cure and then the recesses are incorporated. Hence, the desired initial shape is already injection-molded to the rotor sheet pack upon overmolding.

According to a further aspect of the present invention, the shaping of recesses is effected subsequently to the overmolding. This has the advantage that a conventional overmolding process can be carried out without respective manufacturing machines having to be adapted, and in a following method step then the configuring is effected separately. Here, it is particularly advantageous that the shaping of recesses can be effected both during the overmolding and also subsequently to the overmolding. For example, a first amount of recesses is provided during the overmolding, and a second amount of recesses is provided subsequently to the overmolding. It is thus possible to combine the two techniques such that at last recesses are present which are realized by means of different configurations of the proposed method. The person skilled in the art recognizes here, how he shapes the recesses, for example, by means of drilling or milling, subsequently to the overmolding. Here, it is particularly advantageous that the balancing is not effected by the milling or drilling itself, as already shown in the prior art, but rather by means of the milling or drilling there are created recesses which only then effect that balancing elements can be incorporated. The proposed milling or drilling is hence not to be regarded as a balancing as such.

According to a further aspect of the present invention, the shaping of the recesses is effected by means of drilling. This has the advantage that conventional methods can be reused and that in a particularly efficient way circular recesses can be produced into which the balancing elements can be inserted. This is advantageous in particular when the balancing elements are present as spheres, for example, steel spheres. It is hence possible to incorporate such spheres into the bores and to fix them in the recesses.

According to a further aspect of the present invention, the shaping of the recesses is effected in dependence on a dimension of balancing elements to be incorporated. This has the advantage that the recesses can have substantially the same geometry as the balancing elements. Therefore, it is possible to merely insert the balancing elements and to incorporate the balancing elements in such a form-fitting fashion into the provided geometry that these get locked therein. Therefore, a fixing of the balancing elements can be effected with little technical effort.

According to a further aspect of the present invention, on at least one end face of the rotor sheet pack there is shaped a disk-shaped contour in which the recesses are incorporated. This has the advantage that a separate protrusion is created into which bores or recesses can be incorporated. At one or at both end faces of the rotor sheet pack there is thus created additional material which is configured to be broad enough, so that this additional material can receive the recesses. It is thus also possible to configure the disk-shaped contour in its thickness such that the desired deepness of the recess can be shaped. Hence, for a deeper recess the disk-shaped contour is to be configured broader in its cross-section, accordingly.

According to a further aspect of the present invention, the recesses are shaped coaxially to the axis of the rotor sheet pack. This has the advantage that the balancing elements can be placed in simple fashion such that a symmetrical weight distribution arises which prevents an imbalance. Therefore, the recesses are hence disposed circularly on the rotor sheet pack or on the plastic overmolding.

According to a further aspect of the present invention, in a further method step there is effected a balancing of the overmolded rotor sheet pack such that balancing elements are incorporated into the recesses provided for this purpose. This has the advantage that the production process is extended such that at the end a balanced rotor element is available. An incorporation of the balancing elements or balancing weights into the recesses provided for this purpose can be effected, for example, such that the balancing elements are pressed or forced into the recesses. The person skilled in the art will recognize here, how he executes an incorporation of the balancing elements into the recesses in dependence on the balancing elements used. Various materials are known which are suited as a balancing weight, which are then incorporated into the recesses in dependence on their material properties.

According to a further aspect of the present invention, for the balancing there are employed spheres, in particular metal spheres or steel spheres, as balancing elements. This has the advantage that already existing balancing elements can be reused and these can be supplied particularly favorably, i.e. with little technical effort. In particular spheres can be incorporated in simple fashion into a recess and are suitable in particular when bores are used as recesses. The spheres can thus be configured such that they form-fittingly flush with the bores and can be easily locked in the bore. In particular metal spheres or steel spheres show a particularly advantageous behaviour as balancing elements, because these have a relatively high weight and thus can equalize an asymmetric material distribution.

According to a further aspect of the present invention, in a further method step the balancing elements are fixed in the plastic overmolding. This has the advantage that in this optional method step further adhesives or filling elements can be incorporated. Typically, the method according to the invention can be executed such that the balancing elements come to lie in the recesses already form-fittingly such that these get locked therein. It is therefore not necessary to carry out a further method step of fixation. This can be provided for safety's sake, however, because this ensures that for the whole operational life of the electric motor the balancing elements remain actually fixed at the desired place.

According to a further aspect of the present invention, the fixing comprises a heat-staking of the balancing elements. This has the advantage that with little technical effort and already known methods there can be caused the technical effect according to the invention, namely that the balancing elements actually remain fixed in the recess. Heat-staking generally means the permanent and form-fitting or force-fitting and sometimes additionally material-locking connection between two elements. This creates a particularly efficient alternative to gluing or soldering or screwing. Heat-staking is alternatively also referred to as hot-stamping to which the present invention is also directed. The heat-staking can be effected such that the balancing elements are directly heat-staked, if these consist of a suitable, formable material. It is further also possible, however, to incorporate further elements which then are heat-staked. For example, a filler material can be incorporated into the recess after the balancing element and this filler material can then be heat-staked such that the recess is closed and thus the balancing element is fixed. The person skilled in the art here recognizes further methods of how he can fix the balancing element in the recess by means of heat-staking.

The object is also achieved by a manufacturing apparatus for producing a positively balanceable internal armature to be used in an electric motor, comprising a manufacturing unit arranged for supplying a rotor sheet pack, and an overmolding unit arranged for overmolding the supplied rotor sheet pack with a thermoplastic, wherein the manufacturing apparatus is arranged for configuring the plastic overmolding such that on at least one end face of the rotor sheet pack there can be shaped recesses for receiving balancing elements.

The object is also achieved by an internal armature to be used in an electric motor, comprising a rotor sheet pack, wherein the rotor sheet pack is overmolded with a thermoplastic such that on at least one end face of the rotor sheet pack there are shaped recesses for receiving balancing elements. There is proposed in particular an internal armature which is produced according to the described method.

The object is also achieved by an electric motor comprising a stator and an internal armature as it was already described.

The use of the term internal armature varies in the literature, electric motors having a stator and a rotor are often referred to as an internal armature. In alternative literature, however, the rotor as such is described as an internal armature, because this rotor is mounted to be rotating in the stator and therefore figuratively runs inside the stator. Herein, an internal armature is to be understood such that it constitutes the rotor. Therefore, an internal armature in the context of the present invention is to be understood such that it is the structural group that has, among other things, permanent magnets which are incorporated in respective cavities, also referred to as pockets. Hence, an internal armature is referred to as a rotor, a rotor element, or quite generally as the counterpart to the stator. The person skilled in the art here recognizes that in the context of the present invention he can also use rotor, rotor element, or rotor structural group as terms for the internal armature. Therefore, an internal armature to be used in an electric motor is proposed.

The object is also achieved by a computer program product having control commands which implement the proposed method or operate the proposed manufacturing apparatus.

According to the invention, it is particularly advantageous that the features of the method may be reflected in structural fashion in the proposed manufacturing apparatus. The method is generally suitable to operate the manufacturing apparatus, or the manufacturing apparatus can execute the method. The person skilled in the art thus recognizes that he can analogously provide method steps as structural features in the manufacturing apparatus. The internal armature is produced by the proposed manufacturing apparatus or by the proposed method. Analogously, the electric motor is also proposed by means of the manufacturing apparatus or at least using the manufacturing apparatus. Therefore, also the internal armature implicitly comprises all the method features as structural features.

### BRIEF DESCRIPTION

Further advantageous configurations are explained in more detail with reference to the enclosed figures. There are shown:

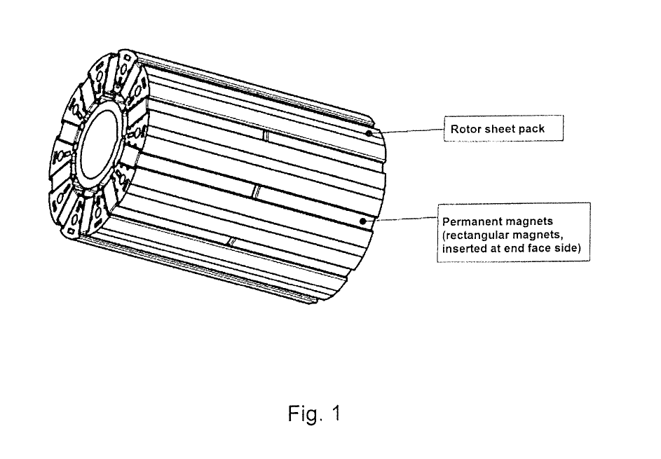

FIG. 1: a rotor sheet pack as it is used according to an aspect of the present invention, in an isometric view;

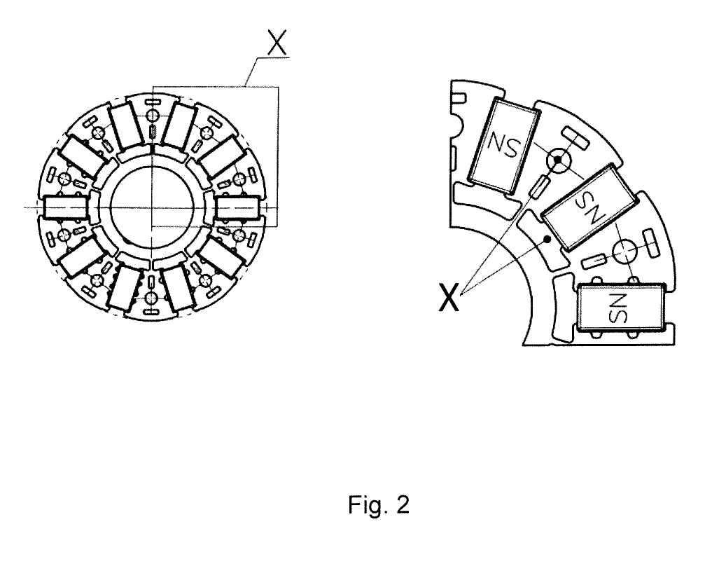

FIG. 2: a rotor sheet pack which is equipped with permanent magnets, in an end-face view, as it is used according to an aspect of the present invention;

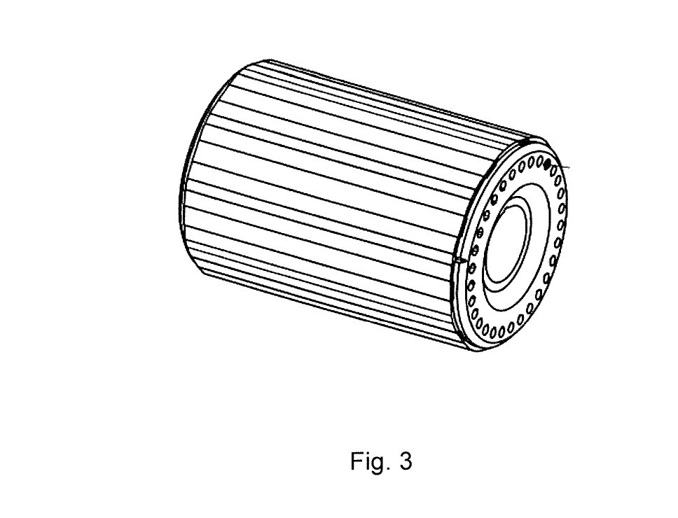

FIG. 3: an equipped rotor sheet pack with injection-molded geometry for receiving balancing spheres according to an aspect of the present invention;

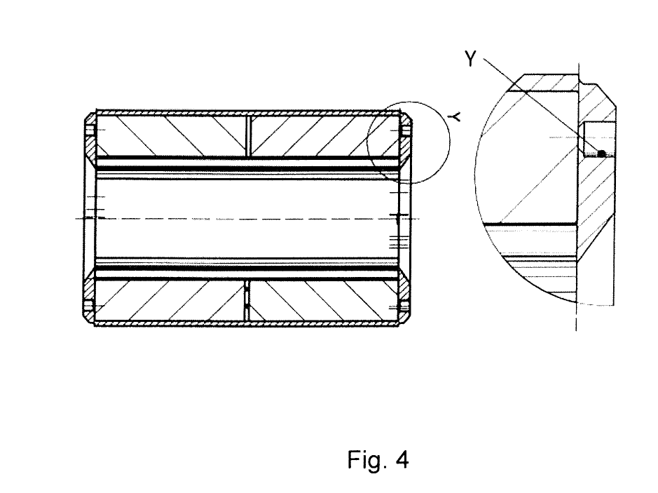

FIG. 4: an equipped and overmolded rotor sheet pack, in a longitudinal section according to an aspect of the present invention;

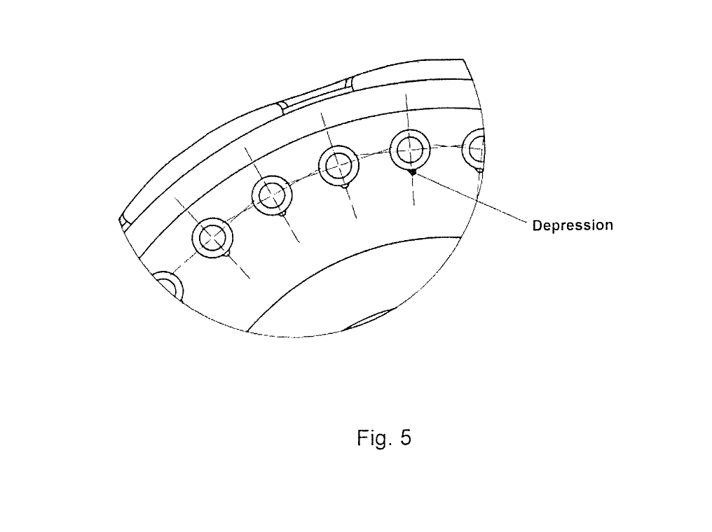

FIG. 5: an air releasing channel for a recess according to an aspect of the present invention;

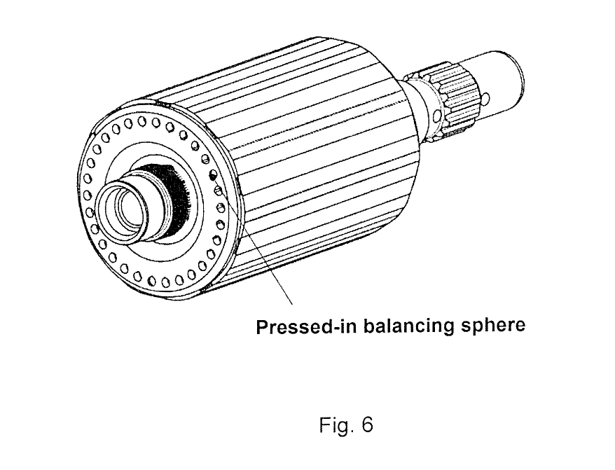

FIG. 6: a balanced rotor with pressed-in balancing sphere according to an aspect of the present invention; and

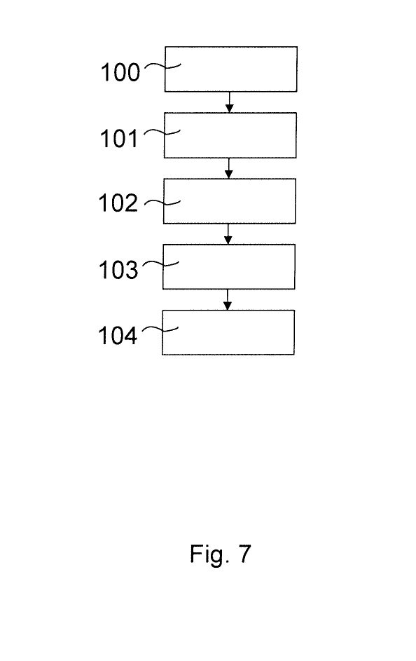

FIG. 7: a schematic flowchart of a method for producing a positively balanceable internal armature according to an aspect of the present invention.

### DETAILED DESCRIPTION

FIG. 1 shows a rotor sheet pack equipped with permanent magnets, in the present case with rectangular magnets which are inserted on the end face side. Therefore, in the present rotor sheet pack there is drawn the end face on the left and on the right. The rotor sheet pack serves as an initial part for overmolding and configuring the plastic overmolding such that on one or on both end faces of the rotor sheet pack there are shaped recesses for receiving balancing elements. Here, it is particularly advantageous that the rotor sheet pack shown in FIG. 1 can be configured as a conventional rotor sheet pack.

FIG. 2 shows on the left side a rotor sheet pack equipped with permanent magnets, which is explained more closely in a detail view according to the section X. In particular the detail on the right side shows, by means of the drawn lines, the longitudinal openings through the rotor sheet pack, into which the plastic is injected later. The injecting is, according to an aspect of the present invention, the overmolding of the supplied rotor sheet pack.

FIG. 3 shows the already overmolded rotor sheet pack and shows in particular on the right side the end face of the equipped rotor sheet pack with the plastic overmolding. The plastic overmolding comprises on the end face side the injection-molded geometry for receiving the balancing spheres. As can be seen in FIG. 3, it is possible to configure the recesses geometrically such that spheres can be employed as balancing elements. For balancing, there can be incorporated individual balancing elements into the recesses, as they are shown on the right side.

FIG. 4 shows in a longitudinal section an equipped rotor sheet pack which is already overmolded, in this case with thermoplastic. Here, the present invention is directed to thermoplastic as an overmolding, but merely according to one aspect. On the right side in FIG. 4 in the detailed view Y there is shown a depression for urging air out of the bore upon pressing in the balancing sphere. Therefore, in the recess there is provided a depression which is suitable to allow air to escape, which escapes upon a pressing in of the balancing element or generally upon incorporation of the balancing element. The equipped rotor sheet pack according to FIGS. 3 and 4 can in general also be referred to as an internal armature.

FIG. 5 shows in a detailed view an air releasing channel and a corresponding depression for allowing air to escape from the bore when the balancing sphere is pressed in.

FIG. 6 shows a balanced rotor or an internal armature, with pressed-in balancing sphere. Depending on the imbalance to be compensated it can also be necessary to press spheres into several bores. Therefore, in the present FIG. 6 on the left side, i.e. the end face, there are drawn several recesses which are supplied by means of the plastic overmolding.

While on account of the selected perspectives always merely one end face is shown, it is also possible that respective recesses are provided, for example, also on the end face which is concealed in FIG. 6. Therefore, it is also possible to configure the plastic overmolding such that on two end faces, i.e. both end faces, of the rotor sheet pack there are shaped recesses for receiving balancing elements.

FIG. 7 shows in a schematic flowchart a method for producing a positively balanceable internal armature to be used in an electric motor, comprising the steps of supplying 100 a rotor sheet pack, overmolding 101 the supplied rotor sheet pack with a thermoplastic, and configuring 102 the plastic overmolding such that on at least one end face of the rotor sheet pack there are shaped recesses for receiving balancing elements. In further optional method steps there is effected a balancing 103 of the internal armature and a fixation 104 of the balancing elements in the plastic overmolding. The person skilled in the art here recognizes that he can execute individual method steps iteratively and/or in a different order.

Therefore, a skilful usage of the plastic overmolding of a rotor of an electric machine is proposed, in such a way that the overmolding on its end face side is developed such that suitable balancing weights can be received. The balancing weights received in the corresponding openings, preferably spheres which are pressed into circular bores, can subsequently be form-fittingly secured against detaching by heat-staking the plastic. Therefore, the plastic overmolding is heat-staked such that, for example, a metal sphere is fixed in the recess.

Upon overmolding the rotor sheet pack, which is equipped with the permanent magnets, with the thermoplastic, in the specific application case there is also injection-molded a cylindrical disk-shaped contour on both end faces of the sheet pack. This contour has a row of openings disposed coaxially to the axis of the sheet pack. In the present case, these are simple, circular openings or bores. By means of these bores the finished assembled rotor can be balanced after the overmolded sheet pack was mounted to the motor shaft. The balancing occurs positively by balancing weights, in the present case customary steel spheres, being forced according to the imbalance to be removed into the bore or bores relevant for this purpose. Optionally, the forged-in spheres can also be relatively simply and efficiently secured against loss by hot-stamping or heat-staking.

The already available overmolding of the rotor with plastic for fixing the permanent magnets inserted in the rotor sheet pack is used, according to the invention, for injection-molding on both end faces of the rotor a geometry for receiving the balancing elements. The balancing is therefore positive. The balancing elements can be simple, very cost-efficient metal spheres. By heat-staking or hot-stamping the balancing elements can additionally be form-fittingly secured against loss in a very simple and efficient fashion. The method thus works cleanly and produces no soiling upon manufacturing or assemblage. This is an essential advantage compared with negative balancing, upon which material is removed. The proposed method is therefore suitable, for example, for a with high demands on cleanness, because no contaminations are caused by the process.

1. A method for producing a positively balanceable internal armature to be used in an electric motor, comprising:
supplying a rotor sheet pack; overmolding the supplied rotor sheet pack with a thermoplastic, and configuring the plastic overmolding such that on at least one end face of the rotor sheet pack there are shaped recesses for receiving balancing elements.

2. The method according to claim 1, wherein the shaping of recesses is effected during the overmolding.

3. The method according to claim 1, wherein the shaping of recesses is effected subsequently to the overmolding.

4. The method according to claim 3, wherein the shaping of the recesses is effected by drilling.

5. The method according to claim 1, wherein the shaping of the recesses is effected in dependence on a dimension of balancing elements to be incorporated.

6. The method according to claim 1, wherein on at least one end face of the rotor sheet pack there is shaped a disk-shaped contour into which the recesses are incorporated.

7. The method according to claim 1, wherein the recesses are disposed coaxially to the axis of the rotor sheet pack.

8. The method according to claim 1, wherein there is effected a balancing of the overmolded rotor sheet pack such that balancing elements are incorporated into the recesses provided for this purpose.

9. The method according to claim 8, wherein for balancing there are employed spheres as balancing elements.

10. The method according to claim 8, wherein the balancing elements are fixed in the plastic overmolding.

11. The method according to claim 10, wherein the fixing comprises a heat-staking of the balancing elements.

12. A manufacturing apparatus for producing a positively balanceable internal armature to be used in an electric motor, comprising:
a manufacturing unit arranged for supplying a rotor sheet pack; an overmolding unit arranged for overmolding the supplied rotor sheet pack with a thermoplastic, characterized in that the manufacturing apparatus is arranged for configuring the plastic overmolding such that on at least one end face of the rotor sheet pack there can be shaped recesses for receiving balancing elements.

13. An internal armature to be used in an electric motor, comprising:
a rotor sheet pack, wherein the rotor sheet pack is overmolded with a thermoplastic, wherein on at least one end face of the rotor sheet pack there are shaped recesses for receiving balancing elements in the thermoplastic.
